(19) United States
(12) Patent Application Publication
(10) Pub. No.: US 2006/0105150 A1
(43) Pub. Date: May 18, 2006

(54) Imaging support containing interference pigments

(75) Inventor: Hubert Maria J. Gillissen, Berkel-Enschot (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/287,149

(22) Filed: Nov. 23, 2005

Related U.S. Application Data
(63) Continuation of application No. PCT/NL04/00376, filed on May 26, 2004.

(30) Foreign Application Priority Data
May 27, 2003 (EP) 03076622.4

(51) Int. Cl. B41M 5/00

(52) U.S. Cl. 428/195.1

(57) ABSTRACT

This invention relates to an imaging support comprising a substrate and at least three resin layers, the outermost layer which is beaming the image comprising of a preferably non-pigmented resin layer, a second resin layer which contains interference pigment(s) and a third, prefereably white pigmented resin layer.

### FIELD OF THE INVENTION

This invention relates to an imaging support, in particular a resin coated paper as a support material for photographic and non-photographic imaging applications.

### BACKGROUND OF THE INVENTION

In general, an imaging support consists of a substrate, which has applied thereto at least one layer, which is bearing the image. A typical example of such an imaging support is an imaging support for photographic image in which a paper substrate is coated with a layer of polymer resin, typically polyethylene. This layer serves to provide waterproofing to the paper, as well as to provide a smooth surface on which the photosensitive layers are applied. Traditionally, photographic image supports require a white-pigmented resin layer attached to the paper substrate. These pigments provide a white appearing surface, enhanced sharpness and opacity and spectrally diffuse layer that provides a pleasing surface for viewing. When images are displayed for advertising and other commercial uses, it is very important to have a print display that is very unique and eye catching.

While images on conventional imaging supports are high in quality for some aspects, they are very flat appearing and lack depth of image. It is very desirable to have objects within an image to appear as though they have depth of image. That is, they appear as though they are higher than the background. This appearance provides a very pleasing appearance to the image and significant commercial value.

In the prior art, various solutions are mentioned for manufacturing such special imaging supports. US-B1-6 291 150 discloses photographic supports that have a highly reflective metallic layer under a photographic image. By placing a highly reflective layer under a photographic layer and separating it by a polymer layer, there is added depth to the image. JP-A-61 259 246, JP-A-2001 201 822 and EP-A-0 180 396 describe supports in which interference pigments are incorporated. The terms “pigments” and “interference pigments” (also referred to as “nacreous pigments”) as used herein are given the meaning defined in Ullmann's Encyclopedia of industrial chemistry vol A20 (1992). The supports known from the above-mentioned patent publications are manufactured with either bar coating a pigment containing liquid on a substrate or by extrusion coating a pigment containing molten resin on a substrate. By placing the interference pigment-containing layer under the image layer, depth is added to the image.

Although the known supports provide for some improvement with respect to the depth of image, there are disadvantages associated with the prior art. US-B1-6 291 150 requires a technically complex multi step process of, depositing a metal layer on a biaxially oriented polymer sheet by vacuum deposition, which metal layer is subsequently laminated to a paper substrate.

The imaging supports described in JP-A-61 259 246, JP-A-2001 201 822 are manufactured with either bar coating a pigment dispersion on a substrate or by extrusion coating a molten resin, loaded with interference pigment and anatase titanium dioxide, on a substrate. In bar coating the pigment dispersion is either a liquid containing electron beam curable compounds or a liquid containing water, a pigment and film forming chemicals such as gelatine. Both methods have their disadvantages like the required use of flammable compounds and radiation danger in case of electron beam curing, or, in the case of water-containing coating liquids, the need for a well controlled drying process to prevent defects that would destroy the surface gloss, but which decreases the manufacturing speed. In extrusion coating, a molten polymer layer is extruded through a slot die at elevated temperatures of 280-340° C. In the extrusion coating process a well-known problem is the formation of so-called die drool, deposition of material on the lip of the slot die, which disturbs the flow of the molten polymer layer leading to defects on the product, which have a negative effect on the visual appearance. This die drool occurs very fast when the molten polymer layer contains interference pigments. So, the quality of the product is degraded and its commercial value is decreased. Severe die drool necessitates the interruption of the manufacturing in order to clean the die lip, leading to a decrease of the productivity.

There remains a need to provide special supports, which create greater depth of image when viewing an image. Also, there remains a need to produce such supports in an economical process, free from defects and at a high manufacturing speed.

### SUMMARY OF THE INVENTION

It is an object of the invention to provide improved imaging supports.

It is another object to provide imaging supports that have added depth of image giving a unique appearance. It is a further object of this invention to produce such supports in an economical process, free from defects and at a high manufacturing speed.

These and other objects of the invention generally are accomplished by an imaging support comprising an intermediate resin layer, which comprises at least one interference pigment, which intermediate resin layer is sandwiched between a top-layer and a bottom-layer, so as to form a multi-layer of at least three layers.

The top-layer bears the image and is furthest away from said substrate. It usually comprises a non-pigmented resin layer, viz. is essentially free from added pigment. The bottom-layer, which is closest to the support, usually comprises a pigmented resin layer. Optionally one or more adhesive layers can be coated between the multi-layer and the substrate.

### DETAILED DESCRIPTION

The present invention is directed to an imaging support comprising a substrate and a polymer layer adhered to said substrate, wherein the polymer layer is a multi-layer comprising at least three resin layers, in which an intermediate resin layer is present in between the layer that is furthest away from said substrate and the resin layer that is nearest to said substrate, which intermediate resin layer contains at least one interference pigment.

The layer that is most distant from said substrate (generally the outermost layer; also referred to herein as “top-layer”) which may be bearing the image preferably comprises a non-pigmented resin. The layer that is situated closest to the substrate (also referred to herein as “bottom-layer”) preferably comprises a pigmented resin.

The supports according to the present invention have numerous advantages over supports known from the prior art. Quality improvements and increased commercial value are obtained by providing imaging supports that have interference pigmented resin layer under the image layer. By placing an interference pigmented resin layer under the image layer, there is added depth to the image. When an observer views such an image from an angle, a perception of depth of image is generated. Such an image is very eye catching and has significant value when compared to conventional two-dimensional images. Enhancement of manufacturing process, improving the economy of the process of producing the imaging support free from defects and at a high production speed are realized surprisingly by placing the interference pigments containing layer in between a non-pigmented resin layer farthest from the substrate and a pigmented layer nearest to the substrate. The interference pigments of the present invention may be selected from titanium oxide coated mica platelets, titanium oxide coated aluminium oxide flakes, metal flake pigments, bismuth oxychloride, basic lead carbonate, and the like and combinations thereof. Preferably, the coated mica platelets, the coated aluminium oxide flakes, or both are coated with anatase titanium oxide, rutile titanium oxide, or combinations thereof. In a preferred embodiment of the invention, the interference pigments in the second layer are selected from anatase titanium oxide, rutile titanium oxide coated mica platelets and combinations thereof. This provides for a good quality, in particular with respect to light fastness and stability. Also these materials are non-toxic. In the most preferred embodiment of the invention, the interference pigments are selected from at least one of anatase titanium oxide and rutile titanium oxide coated mica platelets, each having an average particle size of 1-50 μm, more preferably from 5-25 μm, with a silver white pearl lustre appearance. These pigments are commercially available under the trade name Iriodin from the company E. Merck, Germany. Examples of the interference pigments which can be used in the second layer of the invention are Iriodin™ 100, Iriodin™ 101, Iriodin™ 110, Iriodin™ 119, Iriodin™ 120, Iriodin™ 121, Iriodin™ 171 and Iriodin™ 173.

The coating weight of the interference pigments in the second layer is limited by technical reasons, costs and quality. The technical reasons are the limitation of the pigment load in a master batch or problems, which happen with extruding high pigment loaded recipes. With respect to the costs it is evident that the cost price of the product is increased by using higher amounts of interference pigments. An effect on the image quality is already observed using an interference pigment amount as low as 0.2 g/m². Further improvements on the depth appearance of the image are generally not observed anymore using interference pigments in an amount over 10 g/m². We obtained good results using an amount from 2 to 4 g/m². Nevertheless, a good or even better appearance is obtained using interference pigment in amounts of between 4 and 10 g/m². The coating weight of the resin in the second layer of the invention is from 0.8 g/m² to 25 g/m², more preferably from 4 g/m² to 20 g/m². In the most preferred embodiment of the invention, the coating weight of the resin in the second layer of the invention ranges from 4 g/m² to 15 g/m².

The type of resin in the second (intermediate) layer of the invention can be chosen from any type of extrusion coating resin known in the art. Preferably the resin in the second layer of the invention is a polyolefin, an olefin copolymer, or a mixture of one or more of these. In the most preferred embodiment of the invention the type of resin used in the present invention is a polyethylene resin or a mixture of different polyethylene resins. Apart from the interference pigments and the resins, the second layer of the present invention may contain small quantities of coloured dyes, optical brighteners, antioxidants, light stabilisers or other substances used as known additives for resin coating imaging supports.

The outermost layer of this invention, which is bearing the image preferably comprises a non-pigmented resin layer on top of the second layer, which contains interference pigment(s). The non-pigmented outermost layer enhances the manufacturing process, improving the economy of the process of producing the imaging support free from defects and at a high production speed.

The coating weight of the resin in the outermost layer of the present invention preferably ranges from 0.5 g/m² to 10 g/m² and more preferably from 1 g/m² to 10 g/m². In the most preferred embodiment of the invention, the coating weight of the resin in the outermost layer of the invention ranges from 1 g/m² to 5 g/m². The type of resin in outermost layer of the invention can be chosen from any type of extrusion coating resin known in the art, preferably the resin in the outermost layer of the present invention is a polyolefin or polyolefin copolymer or a mixture of olefinic (co-)polymers. In the most preferred embodiment of the invention the type of resin used in the outermost layer of the present invention is a polyethylene resin or a mixture of different polyethylene resins. Apart from resins, the outermost layer of the present invention may contain small quantities of coloured dyes, optical brighteners, antioxidants, light stabilisers ore other substances used as known in the art additives for resin coated imaging supports.

The third (bottom-) layer of this invention can be pigmented with any pigment, usually non-interference pigments. Most commonly used is a white pigment, which greatly enhances the whiteness, and opacity of the imaging support and, in case of a photographic support, increases the sharpness of the image. It was furthermore found that particularly good results are obtained if mixing of non-interference pigment with interference pigment is avoided as much as possible. This is obtained by providing both type of pigments in separate layers. It was found that the positive effect of the interference pigment is reduced or may even be lost, when mixing with non-interference pigments occurs. By applying the non-interference pigments in a separate layer we benefit from the dept of the image generated by the interference pigment and the colour generated by the non-interference pigments.

In the preferred embodiment of this invention a white pigment is used. This white pigment may comprise any of the white pigments known in the art, such as anatase type titanium oxide, rutile titanium oxide, zinc oxide, zinc sulphide and the like. In the most preferred embodiment of the invention the white pigment in the third layer of the present invention comprises anatase type and/or rutile type titanium oxide. Preferably, the particle size, of the anatase type and/or rutile type titanium oxide is between 0.2 μm and 0.4 μm.

The coating weight of the white pigment in the third layer of the present invention ranges from 0.5 g/m² to 7.5 g/m² and preferably from 0.75 g/m² to 5 g/m². In the most preferred embodiment of the invention, the coating weight of the white pigment in the third layer of the invention ranges from 1 g/m² to 4.5 g/m². The coating weight of the resin in the third layer of the invention is from 5 g/m² to 25 g/m², more preferably from 5 g/m² to 22.5 g/m².

The type of resin in third layer of the invention can be chosen from any type of extrusion coating resin known in the art, preferably the resin in the third layer of the present invention is a polyolefin or polyolefin copolymer or a mixture of olefinic (co-)polymers. In the most preferred embodiment of the invention the type of resin used in the third layer of the present invention is a polyethylene resin or a mixture of different polyethylene resins. Apart from resins and white pigment, the third layer of the present invention may contain optionally small quantities of coloured pigments like ultramarine blue, ultramarine violet and quinacridone red or coloured dyes for colour adjustment, optical brighteners, antioxidants, light stabilisers ore other substances used as known additives for resin coating imaging supports.

The resins or resin mixtures in different layers of the present invention can be chosen independently from each other and may be chosen different from each other depending on the intended properties of the end product.

According to the present invention, one or more additional layers can be provided to improve adhesion to the substrate of the imaging support e.g. with materials as described in US-A-5 466 519. This layer may be added below the third layer when required.

The substrate of the imaging support of the present invention can be chosen from any substrate known in the art like natural pulp containing high quality paper, photographic base paper, coated paper, synthetic paper or thermoplastic sheet. The preferred substrate in the present invention is natural pulp containing high quality paper or photographic base paper or coated paper with a base weight of 80-300 g/m², and most preferably with a base weight of 150 to 200 g/m².

The imaging support of the present invention can be manufactured by extrusion coating techniques as described in the art. Most preferably the imaging support of the present invention is manufactured by a co-extrusion technique in which all resin layers of the present invention are applied to the substrate at the same time using feed block techniques or multi manifold die techniques. This greatly increases the economy of the production of the imaging support because it does not require the complex multi-step manufacturing method as described in US-B1-6 291 150 which comprises vacuum disposition of a metal layer on a biaxial oriented polymer sheet and the subsequent lamination of the sheet to a paper substrate. Using the co-extrusion technique of the present invention, the manufacturing speed can be increased greatly compared to bar coating proposed in JP-A-61 259 246 and JP-A-2001 201 822 because it omits the need for a well controlled, slow drying process to prevent defects that destroy the surface gloss. Using the co-extrusion technique of the present invention, the inclusion of layers without interference pigments on top and below the interference pigments containing layer leads to a defect free imaging support because die drool is prevented. This greatly increases the economy of the production of the imaging support.

In the extrusion line the substrate can be treated prior to the extrusion coating of the resin layers in order to improve adhesion between the resin layers and the substrate like corona treatment, plasma treatment, flame treatment, ozone treatment or heat treatment, or combinations thereof. In the extrusion line the surface structure of the imaging support can be chosen by the choice of the surface structure of the cooling roll, e.g. glossy, dull or structured. In the most preferred embodiment of the present invention the surface structure of the chill roll used for the manufacturing of the imaging support is a glossy cooling roll. To avoid dust during the manufacturing of the image support of the present invention, the interference pigment s and white pigments are pre-dispersed in a resin in a master batch or compound, which are mixed and molten in the required ratio with virgin resin in the extrusion coating process.

The support of this invention can be used for a very wide range of imaging application. It will give in a photographic application pictures with improved depth of image, but also in other applications like ink jet or dye sublimation application the base of the present invention give images with improved depth.

The invention is now elucidated on the basis of the following Examples.

### EXAMPLES

All experiments were run on a co-extrusion line equipped with two 4 ½″ (1.27 cm) and one 2.5″ (6.35 cm) extruders, and a coat-hanger die. Melt temperatures used ranged from 320-325° C. All tests were run at a line speed of 300 m/min. The substrate used in the test was photographic base paper. The paper substrates were corona treated prior to extrusion coating by in-line corona treatment stations. All experiments were performed using glossy fine matte chill rollers.

### Comparative Example 1 (Reference)

Photographic base paper was coated using co-extrusion with the following multi-layer on the image bearing side:

| | | Total | | |
|---|---|---|---|---|
| | | coating | | Added |
| Layer | | weight | | Amount |
| No. | Layer | (g/m²) | Composition | (%) |
| 1 | Outermost | 1 | Low density polyethylene | 50 |
| | | | Linear low density Polyethylene | 50 |
| 2 | Second | 13 | Low density polyethylene | 74.8 |
| | layer | | Titanium Oxide | 25 |
| | | | Ultramarine pigments | 0.2 |
| 3. | Third layer | 17 | Low density polyethylene | 94.8 |
| | | | Titanium Oxide | 5 |
| | | | Ultramarine pigments | 0.2 |

The titanium oxide pigment used in this example was an anatase type titanium oxide, a non-interference pigment with an average particle size of 0.2 μm. The ultramarine pigments were a mixture of ultramarine violet and ultramarine blue in the ratio of 2.75:1.70. Pigments were applied from master batches.

On the non-image bearing side of the substrate of this example was extrusion coated 20 g/m² of a 1:1 mixture of high-density polyethylene and low-density polyethylene.

### Comparative Example 2

Photographic base paper was coated with co-extrusion with the following multi-layer on the image bearing side:

| | | Total | | |
|---|---|---|---|---|
| | | coating | | Added |
| Layer | | weight | | Amount |
| No. | Layer | (g/m²) | Composition | (%) |
| 1 | Outermost | 1, 5, | Low density polyethylene | 55 |
| | | 10 and | Linear low density Polyethylene | 25 |
| | | 15 g/m² | Iriodin ™ 110 | 20 |
| 2 | Second | 13 | Low density polyethylene | 74.8 |
| | layer | | Titanium Oxide | 25 |
| | | | Ultramarine pigments | 0.2 |
| 3. | Third layer | 17 | Low density polyethylene | 94.8 |
| | | | Titanium Oxide | 5 |
| | | | Ultramarine pigments | 0.2 |

The titanium oxide pigment used in the intermediate layer of this example was an anatase type titanium oxide, a non interference pigment with an average particle size of 0.2 μm. The ultramarine pigments were a mixture of ultramarine violet and ultramarine blue in the ratio of 2.75:1.70. Pigments were applied from master batches. The Iriodin™ 110 master batch contains 40% Iriodin™ and 60% low-density polyethylene.

On the non-image bearing side of the substrate of this example was extrusion coated 20 g/m² of a 1:1 mixture of high-density polyethylene and low-density polyethylene.

In all cases, die drool appeared directly as soon as the Iriodin™ 110 containing layer came out of the die, could not be cleaned without directly re-appearing, and leading to uncountable numbers of defects. This die drool occurred at low output and also at high output, with comparable speed.

All imaging supports showed spot defects, line defects and elongated defects upon visual inspection. The number of defects exceeded 5 defects/cm² in all supports. The size of the defects reached 2 mm² and for some defects even higher. The defects reduced the visual appeal of the images to an unacceptable level.

### Inventive Example 3

Photographic base paper was coated with co-extrusion with the following multi-layer on the image bearing side:

| | | Total | | |
|---|---|---|---|---|
| | | coating | | Added |
| Layer | | weight | | Amount |
| No. | Layer | (g/m²) | Composition | (%) |
| 1 | Outermost | 1 | Low density polyethylene | 50 |
| | | | Linear low density Polyethylene | 50 |
| 2 | Second | 1, 5, | Low density polyethylene | 55 |
| | layer | 10 and | Linear low density Polyethylene | 25 |
| | | 15 g/m² | Iriodin 110 | 20 |
| 3. | Third layer | 20 | Low density polyethylene | 79.7 |
| | | | Titanium Oxide | 20 |
| | | | Ultramarine pigments | 0.3 |

The titanium oxide pigment used in this example was an anatase type titanium oxide. The ultramarine pigments were a mixture of ultramarine violet and ultramarine blue in the ratio of 2.75:1.70. Pigments were applied from master batches. The Iriodin 110 master batch contains 40% Iriodin and 60% low-density polyethylene.

On the non-image bearing side of the substrate of this example was extrusion coated 20 g/m² of a 1:1 mixture of high-density polyethylene and low-density polyethylene.

In none of these recipes die drool appeared.

In all the imaging supports no visible defects were found.

### Inventive Example 4

Photographic base paper was coated with co-extrusion with the following multi-layer on the image bearing side:

| | | Total | | |
|---|---|---|---|---|
| | | coating | | Added |
| Layer | | weight | | Amount |
| No. | Layer | (g/m²) | Composition | (%) |
| 1 | Outermost | 1 | Low density polyethylene | 50 |
| | | | Linear low density Polyethylene | 50 |
| 2 | Second | 1, 5, | Low density polyethylene | 55 |
| | layer | 10 and | Linear low density Polyethylene | 25 |
| | | 15 g/m² | Iriodin 110 | 20 |
| 3. | Third layer | 20 | Low density polyethylene | 80 |
| | | | Titanium Oxide | 20 |

The titanium oxide pigment used in this example was an anatase type titanium oxide. The pigments were applied from master batches. The Iriodin 110 master batch contains 40% Iriodin and 60% low-density polyethylene.

On the non-image bearing side of the substrate of this example was extrusion coated 20 g/m² of a 1:1 mixture of high-density polyethylene and low-density polyethylene.

In none of these recipes die drool appeared nor associated defects occurred.

### Example 5

All image supports of the present invention were coated with photographic emulsion. On the resulting photographic papers images were printed. The images were evaluated for relative depth of image. This was done by assessing the visual appeal on a 1-10-scale. 1 being a standard photographic print and 10 being a mirror. The results are given in Table 1

TABLE 1

| Example | Description | Depth assessment |
|---|---|---|
| Example 1 | Standard Control | 1 |
| Example 3 | 0.2 g/m² pigment | 3 |
| | 1 g/m² pigment | 5 |
| | 2 g/m² pigment | 6 |
| | 3 g/m² pigment | 8 |
| Example 4 | 1 g/m² pigment | 5 |
| | 2 g/m² pigment | 6 |
| | 3 g/m² pigment | 8 |

The depth assessment was a subjective rating of the mirror like appearance of the image. Since all samples were better than the control, the control sample was assigned a value of 1. A value of 10 is considered to be a highly polished glass mirror. A relative rating was assigned to the other samples.

The invention of this patent has been described in detail with particular reference to certain preferred embodiments thereof, but it will be understood that variations and modifications can be effected within the spirit and scope of the invention.

1. An imaging support comprising a substrate and a polymer layer adhered to said substrate, wherein the polymer layer is a multi-layer comprising at least three resin layers, in which an intermediate resin layer is present in between the layer that is furthest away from said substrate and the resin layer that is nearest to said substrate, which intermediate resin layer contains at least one interference pigment.

2. An imaging support according to claim 1, in which the layer that is furthest away from said substrate is a non-pigmented polymer resin layer.

3. An imaging support according to claim 1, in which the layer that is nearest to the substrate is a pigmented polymer resin layer.

4. An imaging support according to claim 1, wherein said at least one interference pigment is selected from the group consisting of titanium oxide coated mica platelets, titanium oxide coated aluminum oxide flakes, metal flake pigments, bismuth oxychloride, basic lead carbonate, and combinations thereof.

5. An imaging support according to claim 1, wherein said at least one interference pigment is selected from the group consisting of anatase type titanium oxide, rutile type titanium oxide coated mica platelets, and combinations thereof.

6. An imaging support according to claim 5, wherein at least one of said pigments has a particle size of between 1 μm and 50 μm.

7. An imaging support according to claim 1, wherein the amount of interference pigments used is between 0.2 and 10 g/m².

8. An imaging support according to claim 1, wherein said intermediate resin layer is applied with a resin coating weight between 0.8 g/m² and 25 g/m².

9. An imaging support according to claim 1, wherein said intermediate resin layer is applied with a resin coating weight between 4 g/m² and 20 g/m².

10. An imaging support according to claim 3, wherein said pigmented polymer resin layer comprises at least one white pigment selected from the group consisting of anatase type titamium oxide, rutile type titanium oxide, and combinations thereof, wherein the white pigment has a particle size between 0.2 μm and 0.4 μm.

11. An imaging support according to claim 3, wherein titanium oxide pigment is used as a pigment in an amount between 0.5 g/m² and 7.5 g/m².

12. An imaging support according to claim 1, wherein said resin layer that is furthest away from said substrate is applied with a resin coating weight of between 0.5 g/m² and 10 g/m².

13. An imaging support according to claim 1, wherein said resin layer that is furthest away from said substrate is applied with a resin coating weight between 1 g/m² and 10 g/m².

14. An imaging support according to claim 1, wherein the layer nearest to the substrate is applied with a resin coating weight between 5 g/m² and 25 g/m².

15. An imaging support according to claim 1, wherein at least one of said resin layers comprises a polyolefin, an olefin copolymer or a mixtures of olefinic co-polymers.

16. An imaging support according to claim 15, wherein the composition of the resins in the applied layers is chosen independently.

17. An imaging support according to claim 16, wherein at least one of said resins is a polyethylene resin or a mixture of polyethylene resins.

18. An imaging support according to claim 1, in which the substrate is selected from natural pulp containing high quality paper, photographic base paper, coated paper, synthetic paper or thermoplastic sheet.

19. A method for manufacturing the support of claim 1, comprising an extrusion coating step.

20. A method for manufacturing the support of claim 19, using a co-extrusion coating technique.

21. A method of using the support according to claim 1 in an imaging application.

22. A method of using the support of claim 18 in a photographic application.

23. An imaging support according to claim 5, wherein at least one of said pigments has a particle size of between between 5 μm and 25 μm.

24. An imaging support according to claim 1, wherein the amount of interference pigments used is between 2 g/m² and 4 g/m².

25. An imaging support according to claim 1, wherein said intermediate resin layer is applied with a resin coating weight between 4 g/m² and 15 g/m².

26. An imaging support according to claim 3, wherein titanium oxide pigment is used as a pigment in an amount between 0.75 g/m and 5 g/m².

27. An imaging support according to claim 3, wherein titanium oxide pigment is used as a pigment in an amount between 2.5 g/m² and 4.5 g/m².

28. An imaging support according to claim 1, wherein said resin layer that is furthest away from said substrate is applied with a resin coating weight between 1 g/m² and 5 g/m².

29. An imaging support according to claim 1, wherein the layer nearest to the substrate is applied with a resin coating weight between 5 g/m² to 22.5 g/m².
